(19) United States
(12) Patent Application Publication
(10) Pub. No.: US 2016/0079641 A1
(43) Pub. Date: Mar. 17, 2016

(54) COMPOSITE ELECTRODE, ELECTROCHEMICAL CELL INCLUDING COMPOSITE ELECTRODE, AND METHOD OF PREPARING ELECTRODE

(71) Applicant: Samsung Electronics Co., Ltd., Suwon-si (KR)

(72) Inventors: Hyunjin Kim, Suwon-si (KR); Victor Roev, Suwon-si (KR); Taeyoung Kim, Seoul (KR); Dongmin Im, Seoul (KR); Wonsung Choi, Yongin-si (KR)

(21) Appl. No.: 14/637,518

(22) Filed: Mar. 4, 2015

(30) Foreign Application Priority Data
Sep. 17, 2014 (KR) 10-2014- 0123703

(51) Int. Cl. H01M 12/08; H01M 4/62; H01M 8/10; H01M 8/22; H01M 10/0564; H01M 10/0525

(52) U.S. Cl. CPC H01M 12/08; H01M 10/0564; H01M 10/0525; H01M 8/1016; H01M 8/22; H01M 4/626; H01M 4/625; H01M 2300/0085

(57) ABSTRACT

A composite electrode includes a gel electrolyte including a solvent, a lithium salt, and an inorganic particle; and an electrode member including at least one of an electrode active material and a conducting material, wherein the gel electrolyte is in a form of a gel.

### CROSS REFERENCE TO RELATED APPLICATION

This application claims priority to and the benefit of Korean Patent Application No. 10-2014-0123703, filed on Sep. 17, 2014, in the Korean Intellectual Property Office, and all the benefits accruing therefrom under 35 U.S.C. §119, the content of which is incorporated herein in its entirety by reference.

### BACKGROUND

1. Field

The present disclosure relates to a composite electrode, an electrochemical cell including the composite electrode, and a method of preparing the composite electrode.

2. Description of the Related Art

Lithium air batteries are known as including an anode capable of incorporation/deincorporation of lithium ions, a cathode that oxidizes/reduces oxygen in the air, and a lithium ion conducting medium, which is disposed between the cathode and the anode.

The lithium air battery uses lithium metal as an anode active material and does not need to store air, which is a cathode active material, in the battery, and thus the lithium air battery may have a high capacity. The lithium air battery has a high theoretical energy density per unit weight of 3500 Wh/kg or higher. The theoretical energy density is about 10 times higher than that of a lithium ion battery.

The lithium air battery uses a liquid electrolyte or a solid electrolyte as an electrolyte.

The liquid electrolyte has a high ionic conductivity, but a large amount of the liquid electrolyte is used to fill pores of a cathode, and thus the total weight of the battery including the liquid electrolyte is increased. Thus, it is difficult to manufacture a lithium air battery with a high energy density when using a liquid electrolyte. Also, the liquid electrolyte may easily leak.

The solid electrolyte has a low ion conductivity compared to that of the liquid electrolyte, and since it is a solid, wettablity at an interface with a carbon-based conducting material is poor, and the battery may not be reversibly charged/discharged since it may be difficult for the solid electrolyte to return to its original location during charging after being squeezed out by a lithium oxide, which is formed within an air electrode during discharging.

Therefore, a method for simultaneously resolving the problems of the liquid electrolyte and the solid electrolyte is needed.

### SUMMARY

Provided is a composite electrode including a gel electrolyte prepared by mixing a liquid electrolyte and an inorganic particle.

Provided is an electrochemical cell including the composite electrode.

Provided is a method of preparing the composite electrode.

Additional aspects will be set forth in part in the description which follows and, in part, will be apparent from the description.

According to an aspect, a composite electrode includes: a gel electrolyte including a solvent, a lithium salt, and an inorganic particle; and an electrode member including at least one of an electrode active material and a conducting material, wherein the gel electrolyte is in the form of a gel.

According to an aspect, an electrochemical cell includes the composite electrode; and a counter electrode.

Also disclosed is a lithium air battery including the electrochemical cell, wherein the conducting material of the composite electrode, which is disposed in the lithium air battery, includes at least one of a porous carbon and a metal.

Also disclosed is a lithium-ion battery including the electrochemical cell disposed in a case.

According to an aspect, a method of preparing the composite electrode includes: combining a solvent, a lithium salt, an inorganic particle, and an electrode member to prepare the composite electrode, wherein the electrode member includes at least one of an electrode active material and a conducting material.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic view of a structure of an embodiment of a lithium air battery;

FIG. 2 is a schematic view of a structure of an embodiment of a lithium ion battery;

FIG. 3 is a schematic view of a structure of a lithium air battery prepared in Example 11;

FIG. 4 is a graph of imaginary resistance (Z′, ohms·cm²) versus real resistance (Z″, ohms·cm²) and is Nyquist plot showing the results of impedance analysis of lithium air batteries prepared in Example 11 and Comparative Example 13;

FIG. 5 is a graph of voltage (Volts, V) versus specific capacity (milliampere-hours per gram of cathode, mAh/g) for the first and second charging/discharging cycles of the lithium air batteries prepared in Example 11 and Comparative Examples 13 to 15; and

FIG. 6 is a graph of potential (volts, the) versus specific capacity (mAh/g) for the first charging/discharging cycle of the lithium air batteries prepared in Example 11 and Comparative Example 17.

### DETAILED DESCRIPTION

Reference will now be made in detail to exemplary embodiments, examples of which are illustrated in the accompanying drawings, wherein like reference numerals refer to like elements throughout. In this regard, the present embodiments may have different forms and shall not be construed as being limited to the descriptions set forth herein. Accordingly, the disclosed embodiments are merely described below, with reference to the figures, to explain various aspects. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, and do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkyl” as used herein means a straight or branched chain, saturated, monovalent hydrocarbon group (e.g., methyl or hexyl).

“Alkoxy” means an alkyl group that is linked via an oxygen (i.e., alkyl-O—), for example methoxy, ethoxy, and sec-butyloxy groups.

“Aryl” means a monovalent group formed by the removal of one hydrogen atom from one or more rings of an arene (e.g., phenyl or napthyl).

“Aryloxy” means an aryl moiety that is linked via an oxygen (i.e., —O-aryl). An aryloxy group includes a C6 to C30 aryloxy group, and specifically a C6 to C18 aryloxy group. Non-limiting examples include phenoxy, naphthyloxy, and tetrahydronaphthyloxy.

“Cycloalkyl” means a monovalent group having one or more saturated rings in which all ring members are carbon (e.g., cyclopentyl and cyclohexyl).

“Alkylene” means a straight or branched chain, saturated, divalent aliphatic hydrocarbon group, (e.g., methylene (—CH₂—) or, propylene (—(CH₂)₃—)).

The prefix “hetero” means that the compound or group includes at least one a heteroatom (e.g., 1, 2, or 3 heteroatom(s)), wherein the heteroatom(s) is each independently N, O, S, Si, or P.

“Transition metal” as defined herein refers to an element of Groups 3 to 11 of the Periodic Table of the Elements.

“Rare earth” means the fifteen lanthanide elements, i.e., atomic numbers 57 to 71, plus scandium and yttrium.

The “lanthanide elements” means the chemical elements with atomic numbers 57 to 71.

Hereinafter, according to exemplary embodiments, a composite electrode, an electrochemical cell including the composite electrode, and a method of preparing the composite electrode are disclosed in further detail.

As used herein, the term “room temperature” refers to a temperature range of more than 10° C. to less than 30° C.

A composite electrode according to an embodiment includes: a gel electrode comprising a solvent, a lithium salt, and an inorganic particle; and an electrode member comprising at least one of an electrode active material and a conducting material, wherein the gel electrolyte comprises a gel phase that comprises the solvent, the lithium salt, and the inorganic particle.

The composite electrode may simultaneously have high ion conductivity and excellent mechanical properties by including the gel electrolyte that includes the solvent, the lithium salt, and the inorganic particle.

As used herein, the term “liquid” refers to a state of a substance that does not maintain a fixed shape at room temperature, takes a shape of a container containing the liquid, and is capable of flowing.

As used herein, the term “liquid electrolyte” refers to an electrolyte that has suitable lithium ion conductivity, does not have a fixed shape at room temperature, takes a shape of a container containing the liquid, and is capable of flowing.

As used herein, the term “solid” refers to a state of a substance that maintains a fixed shape at room temperature, does not flow, and does not intentionally include a low molecular weight material such as water or an organic solvent which is liquid at room temperature.

As used herein, the term “solid electrolyte” refers to an electrolyte that maintains a fixed shape at room temperature, does not flow, has lithium ion conductivity and does not intentionally include a low molecular weight material such as water or an organic solvent which is liquid at room temperature. Even when a solvent is used in the preparation process, the “solid electrolyte” includes an electrolyte from which the solvent has been substantially removed, for example by drying or evacuation.

As used herein, the term “gel” or “gel phase” refers to a state of a substance that is capable of maintaining a fixed shape at room temperature, does not flow at a steady-state, and intentionally includes a low molecular weight material such as water or an organic solvent which is liquid at room temperature.

As used herein, the term “gel electrolyte” refers to material which has suitable lithium ion conductivity, is capable of maintaining a fixed shape at room temperature, does not flow at a steady-state, and intentionally includes a low molecular weight material such as water or an organic solvent, which is liquid at room temperature.

The term “low molecular weight” means a molecular weight of less than 1000 Daltons (Da).

The gel electrolyte may be prepared by combining a solvent, a lithium salt, and an inorganic particle. A polymer may be omitted from the combination used to provide the gel electrolyte. In an embodiment, a polymer may be additionally added into the gel electrolyte, and when it is added, the content of the polymer in the gel electrolyte may be less than 10 wt %, less than 5 wt %, less than 1 wt %, or less than 0.1 wt %, or may be 0.0001 wt % to 1 wt %, or 0.001 wt % to 0.5 wt %. The gel electrolyte is a gelated product that is prepared by mixing a liquid electrolyte, which includes the solvent and the lithium salt, with the inorganic particle. The gel electrolyte may be prepared by forming a gel phase, which has the inorganic particle dispersed in a matrix comprising a low molecular weight organic compound, such as a solvent. In this regard, since the gel electrolyte includes the low molecular weight organic compound as a primary ingredient, an ionic conductivity of the gel electrolyte may be greater than that of a polymer electrolyte. Further, the gel electrolyte includes the low molecular weight organic compound as a primary ingredient, and thus the gel electrolyte may microscopically have substantially the same physical properties as those of a liquid. Thus, the gel electrolyte may provide high ion conductivity and have excellent wettability and may effectively accommodate a volume and/or shape change of an electrode, which may occur during a charging/discharging process.

For example, and while not wanting to be bound by theory, it is understood that at a cathode of a lithium air battery, which includes a polymer electrolyte as solid electrolyte, during discharging of the battery, the polymer electrolyte is expelled to the outside of the cathode by a lithium oxide which is generated inside the cathode, and then, during charging of the battery, the polymer electrolyte may not return to a space formed by decomposition of the lithium oxide. In contrast, in a composite cathode of a lithium air battery including the gel electrolyte, during discharge of the battery, a gel electrolyte is expelled to the outside of the cathode by a lithium oxide generated inside the cathode, and then, during charge of the battery, the gel electrolyte may easily return, as like a liquid, to a space formed by decomposition of the lithium oxide.

For example, when a liquid electrolyte including the solvent and the lithium salt are combined with the inorganic particle, the inorganic particle increases friction at an interface with the liquid electrolyte, and thus a viscosity of the liquid electrolyte may increase, thereby forming the gel electrolyte. The inorganic particle may serve as a gelating agent.

Further, since the gel electrolyte is macroscopically in a gel state, unlike the liquid electrolyte, problems such as leakage of an electrolyte may be prevented or reduced, and the gel electrolyte may be easily molded into various shapes.

The gel electrolyte included in the composite electrode may form a gel phase without including a polymer, and thus the gel electrolyte according to an embodiment is different from an electrolyte which includes a polymer and is prepared, for example, by adding a low molecular weight material such as water or an organic solvent to a polymer.

Further, in another embodiment, other components, such as a polymer, may be included in the gel electrolyte, which is prepared by combining the solvent, the lithium salt, and the inorganic particle.

In the composite electrode, the inorganic particle may be electrochemically inert. That is, the inorganic particle, which is used as a gelating agent in the gel electrolyte, is electrochemically inert, i.e., not reduced or oxidized between 0 and 4.5 volts versus lithium, and thus the inorganic particle is different from the electrode active material, which is electrochemically active and can be reduced or oxidized between 0 and 4.5 volts versus lithium. That is, the inorganic particle may substantially not be involved in an electrochemical reaction, and thus a change in an oxidation number of an element, e.g., a metal which is included in the inorganic particle, for example by intercalation/deintercalation of lithium ions, may not occur. Further, the inorganic particle may be a non-carbon-based inorganic particle or a non-metal-based inorganic particle. Further, the inorganic particle may be an electrically insulating material. The inorganic particle may be different from the conducting material, which is electrically conducting and is included in the electrode member.

Examples of the inorganic particle may include at least one selected from a metal oxide, a metal nitride, a metal nitrate, a metal carbide, and a noble metal, e.g., Au, Pt, Ir, Pd, Os, Ag, Rh, and Ru.

Examples of the inorganic particle may include at least one selected from SiO₂, TiO₂, Al₂O₃, and AlN, is not limited thereto, and any suitable material available in the art that may be used as the inorganic particle.

A diameter of the inorganic particle may be less than 100 nanometers (nm). When a size of the inorganic particle is greater than 100 nm, a stable gel may not form. For example, a size of the inorganic particle may be 50 nm or less. For example, a size of the inorganic particle may be 40 nm or less. For example, a size of the inorganic particle may be 30 nm or less. For example, a size of the inorganic particle may be 20 nm or less. For example, a size of the inorganic particle may be in a range of about 5 nm to about 100 nm, or about 7 nm to about 50 nm, or about 5 nm to about 20 nm. A size of the inorganic particle may be a diameter of the inorganic particle. When a diameter of the inorganic particle is within these ranges, a more stable gel may be formed.

In the composite electrode, an amount of the inorganic particle may be less than about 20 weight percent (wt %), based on the total weight of the gel electrode. When an amount of the inorganic particle is about 20 wt % or greater, a stable gel may not form. For example, in the composite electrode, an amount of the inorganic particle may be in a range of about 1 wt % to about 20 wt %, based on the total weight of the gel electrolyte. For example, in the composite electrode, an amount of the inorganic particle may be in a range of about 3 wt % to about 20 wt %, based on the total weight of the gel electrode. For example, in the composite electrode, an amount of the inorganic particle may be in a range of about 5 wt % to about 20 wt %, based on the total weight of the gel electrolyte. When an amount of the inorganic particle is within these ranges, a more stable gel may be formed.

The inorganic particle may be porous. For example, a Brunauer-Emmett-Teller (BET) specific surface area of the inorganic particle may be about 300 square meters per gram (m²/g) or greater. For example, a BET specific surface area of the inorganic particle may be about 400 m²/g or greater. For example, a BET specific surface area of the inorganic particle may be about 500 m²/g or greater. For example, a BET specific surface area of the inorganic particle may be about 600 m²/g or greater. For example, a BET specific surface area of the inorganic particle may be about 700 m²/g or greater. In an embodiment a BET specific surface area of the inorganic particle may be about 300 m²/g to about 1000 m²/g.

In the composite electrode, a shape of the inorganic particle may be a spherical shape, but the shape is not limited thereto, and the inorganic particle may have any suitable shape, such as a shape that provides an increase of a viscosity of the liquid electrolyte. For example, the inorganic particle may be non-spherical particle.

In the composite electrode, a molecular weight of the solvent may be less than about 1000 Daltons (Da). When the solvent is an oligomer, the molecular weight may be a number average molecular weight (Mn). When a molecular weight of the solvent is greater than about 1000 Da, a phase state of the solvent may be solid, not liquid, at room temperature. For example, in the composite electrode, a molecular weight of the solvent may be about 900 Da or less. For example, in the composite electrode, a molecular weight of the solvent may be about 800 Da or less. For example, in the composite electrode, a molecular weight of the solvent may be about 700 Da or less. For example, in the composite electrode, a molecular weight of the solvent may be about 600 Da or less. For example, in the composite electrode, a molecular weight of the solvent may be about 500 Da or less. In an embodiment, a molecular weight of the solvent may be about 18 Da to about 1000 Da, or about 18 Da to about 500 Da, or about 20 Da to about 250 Da. When a molecular weight of the solvent is within these ranges, a further stable gel may be formed.

In the composite electrode, examples of the solvent may include at least one selected from an organic solvent, an ionic liquid, and an oligomer, but an embodiment is not limited thereto, and any suitable solvent that is liquid at room temperature may be used. For example, the solvent may be liquid at 25° C.

Examples of the organic solvent may include at least one selected from an ether-based solvent, a carbonate-based solvent, an ester-based solvent, and a ketone-based solvent.

Examples of the organic solvent may include at least one selected from propylenecarbonate, ethylenecarbonate, fluoroethylenecarbonate, vinylethylenecarbonate butylenecarbonate, dimethylcarbonate, diethylcarbonate, methylethylcarbonate, methylpropylcarbonate, ethylpropylcarbonate, methylisopropylcarbonate, dipropylcarbonate, dibutylcarbonate, benzonitrile, acetonitrile, tetrahydrofuran, 2-methyltetrahydrofuran, γ-butyrolactone, dioxolane, 4-methyldioxolane, dimethylacetamide, dimethylsulfoxide, dioxane, 1,2-dimethoxyethane, sulfolane, dichloroethane, chlorobenzene, nitrobenzene, succinonitrile, diethyleneglycol dimethylether (DEGDME), tetraethyleneglycol dimethylether (TEGDME), polyethyleneglycol dimethylether (PEGDME), dimethylether, diethylether, dibutylether, dimethoxyethane, 2-methyltetrahydrofuran, and tetrahydrofuran, but an embodiment is not limited thereto, and any suitable organic solvent available in the art that is liquid at room temperature may be used. The PEGDME may have a molecular weight of about 300 Daltons (Da) to about 1000 Da, or about 400 Da to about 600 Da, or about 500 Da.

For example, the ionic liquid may be represented by at least one selected from Formula a, and Formula b.

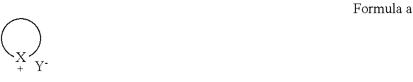

In Formula a,

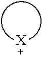

is a 3 to 31 membered ring comprising a C2-C30 ring and at least one heteroatom, where the ring may be aliphatic or aromatic, and may include one or more (e.g., 1 to 3) additional heteroatoms, such as N, O, P, or S. In an embodiment X is —N(R)ₙ—, ═N(R)ₙ—, —P(R)ₙ—, or ═P(R)ₙ— wherein n is 1 or 2 and wherein each R is independently a hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkyleneoxide group; and Y⁻ is an anion, and may be a halogen, such as F⁻, Cl⁻, Br⁻, or I⁻.

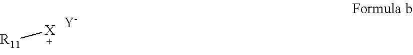

In Formula b, X is —N(R)₃ or —P(R)₃ wherein each R is independently a hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkyleneoxide group; wherein R₁₁ is an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkyleneoxide group; and Y⁻ is an anion.

For example,

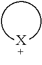

in Formula a may be represented by a cation of Formula c, and

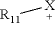

in Formula b may be a cation that is represented by a cation of Formula d.

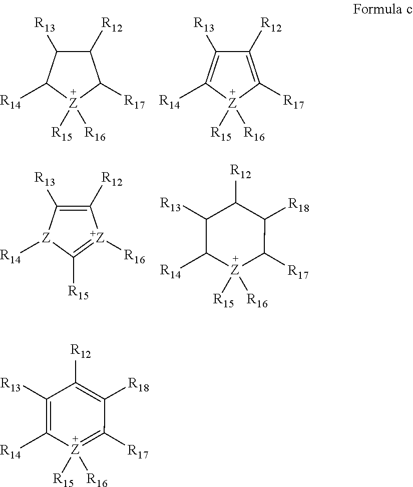

In Formula c, Z denotes N or P; and R₁₂ to R₁₈ are each independently a hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkyleneoxide group.

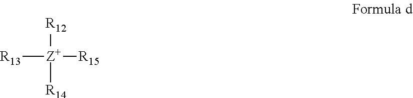

In Formula d, Z denotes N or P; and R₁₂ to R₁₅ are each independently a hydrogen, an unsubstituted or substituted C1-C30 alkyl group, an unsubstituted or substituted C1-C30 alkoxy group, an unsubstituted or substituted C6-C30 aryl group, an unsubstituted or substituted C6-C30 aryloxy group, an unsubstituted or substituted C3-C30 heteroaryl group, an unsubstituted or substituted C3-C30 heteroaryloxy group, an unsubstituted or substituted C4-C30 cycloalkyl group, an unsubstituted or substituted C3-C30 heterocycloalkyl group, or an unsubstituted or substituted C2-C100 alkylene oxide group.

Examples of the ionic liquid may include at least one selected from N,N-diethyl-N-methyl-N-(2-methoxyethyl)ammonium tetraborate ([DEME][BF₄]), diethylmethylammonium trifluoromethanesulfonate ([dema][TfO]), dimethylpropylammonium trifluoromethanesulfonate ([dmpa][TfO]), diethylmethylammonium trifluoromethanesulfonylimide ([dema][TFSI]), and methylpropylpiperidinium trifluoromethanesulfonylimide ([mpp][TFSI]), but an embodiment is not limited thereto, and any suitable organic solvent available in the art that is liquid at room temperature may be used.

In the composite electrode, examples of the lithium salt may include at least one selected from lithium bis(trifluoromethane)sulfonamide (LiTFSI), LiPF₆, LiBF₄, LiAsF₆, LiClO₄, LiNO₃, lithium bis(oxalato) borate (LiBOB), LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and lithium trifluoromethanesulfonate (LiTFO), but an embodiment is not limited thereto, and any lithium salt available in the art may be used.

In the gel electrolyte, a concentration of the lithium salt may be in a range of about 0.01 molar (M) to about 2 M, about 0.05 molar (M) to about 1.8 M, about 0.1 molar (M) to about 1.6 M, but an embodiment is not limited thereto, and any appropriate concentration may be used. When a concentration of the lithium salt is within this range, a battery may have improved battery characteristics.

In the composite electrode, an ion conductivity of the gel electrolyte may be about 1×10⁻⁴ S/cm or greater at a temperature of 25° C. For example, in the composite electrode, an ionic conductivity of the gel electrolyte may be about 3×10⁻³ S/cm or greater at a temperature of 25° C. For example, in the composite electrode, an ionic conductivity of the gel electrolyte may be about 5×10⁻³ S/cm or greater at a temperature of 25° C. For example, in the composite electrode, an ionic conductivity of the gel electrolyte may be about 1×10⁻² S/cm or greater at a temperature of 25° In an embodiment, an ionic conductivity of the gel electrolyte may be about 3×10⁻³ S/cm to about 3×10² S/cm, or about 1×10⁻² S/cm to about 3×10 S/cm.

Since the gel electrolyte may not include a polymer and includes the solvent, which is a low molecular weight compound, as a primary ingredient, and thus an ionic conductivity of the gel electrolyte may be 50% or more than that of a gel electrolyte including a polymer as a primary ingredient.

For example, the gel electrolyte may be a strong gel that does not flow down along an inner wall from a bottom of a vial even when the vial is held upside down at a temperature of 60° C. for 24 hours.

For example, the gel electrolyte may comprise a solvent, a lithium salt, and an inorganic particle, and, while not including other additional components, the gel electrolyte may be formed as a transparent gel.

In the composite electrode, a composition ratio of a cathode member and the gel electrolyte may be about 200 parts to about 800 parts, or about 250 parts to about 750 parts, or about 300 parts to about 700 parts by weight of the gel electrolyte, with respect to 100 parts by weight of the cathode member. When an amount of the gel electrolyte is less than 200 parts by weight, a homogeneous and stable electrode paste composition may not be obtained, and when an amount of the gel electrolyte is greater than 800 parts by weight, a space between carbons in the conducting material increases, and thus a conductivity of the composite electrode may decrease.

In the composite electrode, the conducting material may include at least one porous material selected from a porous carbon-based material and a porous metal-based material. The porous material may be any suitable material available in the art as long as the material has suitable conductivity. For example, the porous material may be a carbonaceous material. Examples of the carbonaceous material may include at least one selected from carbon black, graphite, graphene, active carbon, and carbon fiber. In particular, examples of the carbonaceous material may include at least one selected from carbon nanoparticles, carbon nanotubes, carbon nanofibers, carbon nanosheets, carbon nanorods, and carbon nanobelts, but they are not limited thereto, and any suitable carbonaceous material having a suitable nanostructure may be used. The carbonaceous material may have a particle size of about 0.01 micrometers (μm) to about 10 μm, or about 0.05 μm to about 1 μm, in addition to having the nanostructure. For example, the carbonaceous material may be in various forms such as particles, tubes, fibers, sheets, rods, or belts in a micrometer dimension.

For example, the carbonaceous material may be mesoporous. For example, a part of or the whole of the carbonaceous material in the various forms may be porous. Due to the inclusion of the porous carbonaceous material, pores may be introduced to the cathode, and thus a porous cathode may be formed. Since the carbonaceous material has the pores, a surface area of the cathode in contact with the electrolyte may increase. Further, supply and diffusion of oxygen within the cathode may be easy, and a space for deposition of products generated during charging/discharging processes may be provided within the cathode.

For example, a BET specific surface area of the porous carbonaceous material may be about 300 m²/g or greater. For example, a BET specific surface area of the porous carbonaceous material may be about 400 m²/g or greater. For example, a BET specific surface area of the porous carbonaceous material may be about 500 m²/g or greater. For example, a BET specific surface area of the porous carbonaceous material may be about 600 m²/g or greater. For example, a BET specific surface area of the porous carbonaceous material may be about 700 m²/g or greater. A BET specific surface area of the porous carbonaceous material may be about 300 m²/g to about 2000 m²/g, or about 400 m²/g to about 1000 m²/g.

Further, examples of the conducting material may include a metallic conducting material such as metal fibers or metal mesh. Moreover, examples of the conducting material may include a metallic powder of, for example, copper, silver, nickel, or aluminum. The conducting material may be porous. The conducting material may be an organic conducting material such as a polyphenylene derivative. The conducting material may be used alone or as a combination thereof. The electrode active material used as a component of the electrode member in the composite electrode may be the same as that used in an electrochemical cell disclosed below.

The composite cathode may have a porous structure including nanopores having a pore diameter in a range of about 40 nm to about 600 nm, about 50 nm to about 300 nm, or about 60 nm to about 250 nm.

In the composite cathode, the inorganic particle, the electrode member, and the solvent may form a 3-phase composite, which provides additional active sites for electrochemical reaction within the composite electrode, which, while not wanting to be bound by theory, are understood to provide enhanced electrochemical cell performance. In the composite cathode, the inorganic particle and the electrode member may be evenly dispersed within the gel electrolyte.

According to another embodiment, an electrochemical cell may include the composite electrode; and a counter electrode, wherein the counter electrode may be a cathode or an anode.

The electrochemical cell may further include at least one additional electrolyte selected from a liquid electrolyte, a gel electrolyte, and a solid electrolyte, wherein the additional electrolyte is disposed between the composite electrode and the counter electrode.

The liquid electrolyte, the gel electrolyte, or the solid electrolyte, which is disposed between the composite electrode and the counter electrode, is not particularly limited, and any suitable electrolyte available in the art may be used.

The liquid electrolyte disposed between the composite electrode and the counter electrode includes a solvent and a lithium salt, and the solvent and the lithium salt may be the same as defined in connection with the solvent and the lithium salt used in the preparation of the gel electrolyte included in the composite electrode.

The sold electrolyte disposed between the composite electrode and the counter electrode may include at least one selected from an ionically conducting polymer, a polymeric ionic liquid (PIL), an inorganic electrolyte, a polymer matrix, and an electronically conducting polymer, but an embodiment is not limited thereto, and any suitable solid electrolyte available in the art may be used. The polymer matrix may not have substantial ionic conductivity or electron conductivity.

For example, the solid electrolyte may include at least one selected from polyethylene oxide (PEO) and a solid graft or block copolymer, and may include at least one selected from poly(diallyldimethylammonium) trifluoromethanesulfonylimide (poly(diallyldimethylammonium)TFSI), Cu₃N, Li₃N, LiPON, Li₃PO₄.Li₂S.SiS₂, Li₂S.GeS₂.Ga₂S₃, Li₂O.11Al₂O₃, Na₂O.11Al₂O₃, (Na_{q}Li_{1-q})₁₊ₓTi₂₋ₓAlₓ(PO₄)₃ (where 0.1≦x≦0.9 and 0≦q≦1), Li₁₊ₓHf₂₋ₓAlₓ(PO₄)₃ (where, 0.1≦x≦0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, a sodium silicate, Li_{0.3}La_{0.5}TiO₃, Na₅MSi₄O₁₂ (where M is a rare earth element such as Nd, Gd, or Dy), Li₅ZrP₃O₁₂, Li₅TiP₃O₁₂, Li₃Fe₂P₃O₁₂, Li₄NbP₃O₁₂, Li₁₊ₓ(MₜAlᵤ,Gaᵥ)ₓ(Ge_{1-y}Ti_{y})₂₋ₓ(PO₄)₃ (where, x≦0.8, 0≦y≦1.0, M is Nd, Sm, Eu, Gd, Tb, Dy, Ho, Er, Tm, or Yb, and 0≦t≦1, 0≦u≦1, and 0≦v≦1), Li_{1+x+y}QₓTi₂₋ₓSi_{y}P_{3-y}O₁₂ (where, 0<x≦0.4, 0<y≦0.6, and Q is Al or Ga), Li₆BaLa₂Ta₂O₁₂, Li₇La₃Zr₂O₁₂, Li₅La₃Nb₂O₁₂, Li₅La₃M₂O₁₂ (where, M is Nb or Ta), and Li₇₊ₓAₓLa₃₋ₓZr₂O₁₂ (where, 0<x<3, and A is Zn).

For example, the solid electrolyte may be an ionically conducting polymer which may include at least one ion conductive repeating unit selected from an ether-based monomer, an acryl-based monomer, a methacryl-based monomer, and a siloxane-based monomer.

For example, the ionically conducting polymer may be at least one selected from polyethyleneoxide, polypropyleneoxide, polymethylmethacrylate, polyethylmethacrylate, polydimethylsiloxane, polyacrylate, polymethacrylate, polymethylacrylate, polyethylacrylate, poly-2-ethylhexyl acrylate, polybutyl methacrylate, poly-2-ethylhexylmethacrylate, polydecylacrylate, and polyethylenevinylacetate.

For example, the ionically conducting polymer may be a copolymer including an ion conductive repeating unit and a structural repeating unit.

For example, the ion conductive repeating unit may be derived from at least one monomer selected from acrylate, methacrylate, methyl acrylate, methyl methacrylate, ethyl acrylate, ethyl methacrylate, 2-ethylhexyl acrylate, butyl methacrylate, 2-ethylhexyl methacrylate, decyl acrylate, ethylene vinylacetate, ethylene oxide, and propylene oxide, and the structural repeating unit may be derived from at least one monomer selected from styrene, 4-bromostyrene, tert-butylstyrene, divinylbenzene, methyl methacrylate, isobutyl methacrylate, butadiene, ethylene, propylene, dimethylsiloxane, isobutylene, N-isopropyl acrylamide, vinylidene fluoride, acrylonitrile, 4-methyl pentene-1-butylene terephthalate, ethylene terephthalate, and vinylpyridine.

For example, the ionically conducting polymer may be a block copolymer including an ion conductive phase and a structural phase. The block copolymer including the ion conductive phase and the structural phase may include a block copolymers as disclosed in U.S. Pat. Nos. 8,269,197 and 8,563,168; and in U.S. Patent publication No. 2011/0206994, the contents of which are incorporated herein by reference in their entirety.

The gel electrolyte disposed between the composite electrode and the counter electrode may be identical to or different from a gel electrolyte included in the composite electrode. The gel electrolyte disposed between the composite electrode and the counter electrode may be obtained by additionally adding a low molecular weight solvent to a solid electrolyte disposed between the composite electrode and the counter electrode. For example, the gel electrolyte may be prepared by including a polymer as a primary ingredient and additionally adding a low molecular weight solvent to the polymer.

For example, the electrochemical cell may be a lithium air battery or a lithium ion battery, but an embodiment is not limited thereto, and any suitable electrochemical cell capable of including the composite electrode may be used.

For example, the electrochemical cell may be a lithium air battery. A conducting material of a composite electrode in the lithium air battery may include at least one of a porous carbon and a metal. The porous carbon and the metal may be respectively the same as the porous carbon-based material and the porous metal-based material described in connection with the composite electrode of the electrochemical cell. The metal may be porous or non-porous.

The lithium air battery may have a reaction mechanism represented by Reaction Scheme 1.

4Li+O₂ [symbol] 2Li₂O E^{o}=2.91V

2Li+O₂ [symbol] Li₂O₂ E^{o}=3.10V Reaction Scheme 1

During discharge, lithium derived from an anode reacts with oxygen introduced from a cathode to generate a lithium oxide, and oxygen is reduced to provide an oxygen reduction reaction (ORR). In contrary, during charge, the lithium oxide is reduced, and oxygen is generated by oxidation in an oxygen evolution reaction (OER). During discharge, Li₂O₂ is deposited in pores of the cathode, and a capacity of the lithium air battery increases as an area of an electrolyte contacting oxygen in the cathode increases.

The lithium air battery may be prepared in the following manner.

First, an air electrode is prepared as a composite electrode. For example, the air electrode may be prepared as follows. A carbon-based material as an electrode member, which is a conducting material, and a gel electrolyte may be mixed, followed by optionally adding an appropriate solvent to prepare an air electrode slurry, followed by coating and drying the slurry on a surface of a current collector; or, optionally, the slurry may be press-molded on the current collector in order to improve an electrode density. The current collector may be a gas diffusion layer. Alternatively, the air electrode slurry may be coated and dried on a surface of a separator or a solid electrolyte layer; or, optionally, the slurry may be press-molded on the separator or the solid electrolyte layer in order to improve an electrode density.

The carbon-based material, as a conducting material, and the gel electrolyte used in the preparation of the air electrode slurry may be the same as described above in connection with the composite electrode.

The air electrode slurry may optionally include a binder. The binder may include a thermosetting resin or a thermoplastic resin. Examples of the binder may include at least one selected from polyethylene, polypropylene, polytetrafluoroethylene (PTFE), polyvinylidene fluoride (PVDF), styrene-butadiene rubber, a tetrafluoroethylene-perfluoroalkylvinylether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethyl vinyl ether-tetrafluoroethylene copolymer, and an ethylene-acrylic acid copolymer. The resin may be used alone or as a combination thereof, but an embodiment is not limited thereto, and any suitable binder available in the art may be used.

The current collector may have a porous structure in the form of a net or a mesh in order to increase a rate of oxygen diffusion. For example, the current collector may be a porous metal plate that comprises stainless steel, nickel, or aluminum, but an embodiment is not limited thereto, and any suitable current collector available in the art may be used. In order to prevent oxidation, the current collector may be coated with a metal or an alloy coating layer having an oxidation-resistant property.

The air electrode slurry may optionally include an oxygen oxidation/reduction catalyst and a conducting material. Also, the air electrode slurry may optionally include a lithium oxide.

A catalyst for oxidation/reduction of oxygen may be included in the composite cathode, and examples of the catalyst may include a noble metal-based catalyst, such as platinum, gold, silver, palladium, ruthenium, rhodium, or osmium; an oxide-based catalyst, such as a manganese oxide, an iron oxide, a cobalt oxide, or a nickel oxide; or an organic metal-based catalyst, such as cobalt phthalocyanine, but an embodiment is not limited thereto, and any suitable catalyst for oxidation and reduction of oxygen in the art may be used.

The catalyst may be supported on a carrier. Examples of the carrier may include at least one selected from an oxide, zeolite, a clay mineral, and carbon. Examples of the oxide may include at least one oxide selected from alumina, silica, zirconium oxide, and titanium dioxide. Further, the oxide may be an oxide including at least one metal selected from Ce, Pr, Sm, Eu, Tb, Tm, Yb, Sb, Bi, V, Cr, Mn, Fe, Co, Ni, Cu, Nb, Mo, and W. Examples of the carbon may include a carbon black, such as Ketjen black, acetylene black, channel black, or lamp black; a graphite, such as natural graphite, artificial graphite, or expanded graphite; an active carbon; and carbon fiber. However, an embodiment is not limited thereto, and any suitable carrier available in the art may be used.

Next an anode is prepared.

The anode may be, for example, a lithium metal thin film. Examples of an alloy based on the lithium metal may include a lithium alloy comprising, for example, at least one selected from aluminum, tin, magnesium, indium, calcium, titanium, and vanadium.

Also, a separator may be disposed between the composite cathode and the anode. The separator may have any suitable composition that may tolerate the operating range of the lithium air battery, and examples of the separator may include a polymer non-woven fabric such as a polypropylene based non-woven fabric or a polyphenylene sulfide based non-woven fabric, and a porous film of an olefin-based resin such as polyethylene or polypropylene, and the separator may include at least two thereof.

An oxygen blocking layer impervious to oxygen may be disposed between the composite cathode and the anode. The oxygen blocking layer may be a lithium ion conducting solid electrolyte film that may serve as a protecting layer that protects the lithium metal anode from directly reacting with impurities, such as oxygen, included in the cathode electrolyte. In this regard, examples of the lithium ion conducting solid electrolyte film that is impervious to oxygen may include lithium ion conducting glass, a lithium ion conducting crystal (ceramic or glass-ceramic), or an inorganic material containing a combination thereof, but an embodiment is not limited thereto, and any suitable solid electrolyte film available in the art may be used as long as the solid electrolyte film has lithium ion conductivity, impervious to oxygen, and may protect an anode. In consideration of chemical stability, an example of the lithium ion conducting solid electrolyte film may be an oxide.

When the lithium ion conducting solid electrolyte film includes a large amount of lithium ion conducting crystals, the electrolyte layer may have a high ion conductivity. For example, an amount of the lithium ion conducting crystals may be about 50 wt % or more, about 55 wt % or more, or about 60 wt % or more, or about 50 wt % to about 99 wt %, or about 60 wt % to about 90 wt %, based on the total weight of the solid electrolyte layer.

Examples of the lithium ion conducting crystals may include a lithium ion conductive crystal having a perovskite structure, such as Li₃N, Li₂₊₂ₓZn₁₋ₓGeO₄ wherein 0≦x≦1 (LISICON), or La_{0.55}Li_{0.35}TiO₃; LiTi₂P₃O₁₂ having a NASICON-type structure; and a glass-ceramic precipitating these crystals.

The lithium ion conducting crystals may be, for example, Li_{1+x+y}(AlₛGa₁₋ₛ)ₓ(TiₜGe₁₋ₜ)₂₋ₓSi_{y}P_{3-y}O₁₂ (where, 0≦x≦1, 0≦y≦1, 0≦s≦1, and 0≦t≦1, for example, 0≦x≦0.4 and 0<y≦0.6, or 0.1≦x≦0.3 and 0.1<y≦0.4). To attain high ion conductivity, a lithium ion conducting crystals not including a grain boundary, which impedes ion conduction, may be used. For example, since a glass-ceramic may rarely include a pore or a grain boundary that interrupts ion conduction, high ion conductivity and excellent chemical stability may be attained.

Examples of the lithium ion conducting glass-ceramic may include lithium-aluminum-germanium-phosphate (LAGP), lithium-aluminum-titanium-phosphate (LATP), and lithium-aluminum-titanium-silicon-phosphate (LATSP).

For example, when a parent glass has a composition of Li₂O—Al₂O₃—TiO₂—SiO₂—P₂O₅ and, when the parent glass is heat-treated to perform crystallization, the primary crystalline phase is Li_{1+x+y}AlₓTi₂₋ₓSi_{y}P_{3-y}O₁₂ (where, 0≦x≦1 and 0≦y≦1), where x and y satisfy, for example, 0≦x≦0.4 and 0<y≦0.6, or, 0.1≦x≦0.3 and 0.1<y≦0.4.

As used herein, the wording “a pore or a grain boundary that impedes ion conduction” refers to a structural feature that impedes ion conduction and reduces the total ion conductivity of an inorganic material, for example reduction of the total ion conductivity of a material to 1/10 or less of an intrinsic value.

For example, the oxygen blocking layer may include Li_{1+x+y}AlₓTi₂₋ₓSi_{y}P_{3-y}O₁₂ (where, 0≦x≦1 and 0≦y≦1). Here, x and y may satisfy, for example, 0≦x≦0.4 and 0<y≦0.6 or 0.1≦x≦0.3 and 0.1<y≦0.4.

For example, the oxygen blocking layer may include Li_{1+x+y}Al(Ti,Ge)₂₋ₓSi_{y}P_{3-y}O₁ (where, 0≦x≦2 and 0≦y≦3), and an example of the oxygen blocking layer may be a solid electrolyte layer including Li_{1.4}Ti_{1.6}Al_{0.4}P₃O₁₂ (LATP).

An anode interlayer may be further disposed between the anode and the oxygen blocking layer. The anode interlayer may be introduced to prevent side reactions that may occur between the anode and the oxygen blocking layer.

The anode interlayer may include a solid polymer electrolyte. For example, the solid polymer electrolyte may be polyethylene oxide (PEO) doped with a lithium salt, and examples of the lithium salt may include LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, and LiAlCl₄.

The lithium air battery may be used in both a lithium primary battery and a lithium secondary battery. Also, a shape of the lithium air battery is not particularly limited, and, for example, the lithium air battery may be of a coin-type, a button-type, a sheet-type, a laminated-type, a cylindrical-type, a flat-type, or a horn-type. In addition, the lithium air battery may be used in a large battery for electric vehicles.

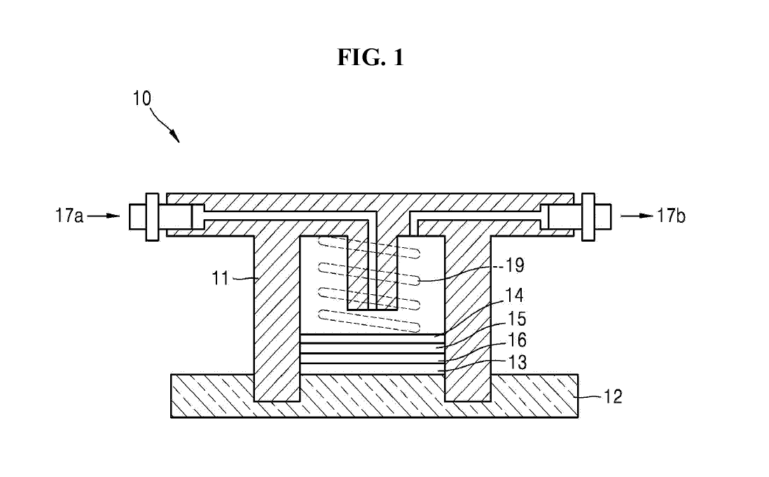

An embodiment of the lithium air battery 10 is schematically illustrated in FIG. 1. The lithium air battery 10 has a composite cathode 15, which uses oxygen as an active material and is disposed adjacent to a first current collector (not shown), an anode 13 including lithium and disposed adjacent to a second current collector 12, and a solid electrolyte film 16 disposed adjacent to the anode including lithium. An anode interlayer (not shown) may be additionally disposed between the anode 13 and the solid electrolyte film 16. The first current collector (not shown) is porous and may serve as a gas diffusion layer through which air may diffuse. A porous carbon paper 14 may be additionally disposed between the first current collector (not shown) and the composite cathode 15. A pressing member 19, through which air may be transferred to an air electrode, is disposed on the first current collector (not shown). A case 11 of an insulating resin material is disposed between the composite cathode 15 and the anode 13, and thus the composite cathode 15 and the anode 13 are electrically separated. Air is charged though an air inlet port 17a and is discharged through an air outlet port 17b. The lithium air battery 10 may be accommodated in a stainless steel reactor.

The term “air” used herein is not limited to the atmospheric air, and may include any suitable combination comprising oxygen, such as air and oxygen, or pure oxygen gas. This broad definition of the term “air” may also be applied to, for example, an air battery or an air electrode.

For example, the electrochemical cell may be a lithium ion battery. An electrode active material of a composite electrode included in the lithium ion battery may include a lithium transition metal oxide represented by one of Formulas 1 to 6.

LiₓCo_{1-y}M_{y}O_{2-α}X_{α} Formula 1

LiₓCo_{1-y-z}Ni_{y}M_{z}O_{2-α}X_{α} Formula 2

LiₓMn_{2-y}M_{y}O_{4-α}X_{α} Formula 3

LiₓCo_{2-y}M_{y}O_{4-α}X_{α} Formula 4

LiₓMe_{y}M_{z}PO_{4-α}X_{α} Formula 5

pLi₂M′O₃-(1−p)LiM″O₂ Formula 6

In Formulas 1 to 6, 0.90≦x≦1.1, 0≦y≦0.9, 0≦z≦0.5, 1−y−z>0, and 0≦α≦2; Me is at least one metal selected from Ti, V, Cr, Mn, Fe, Co, Ni, Cu, Al, Mg, Zr, and B; M is at least one element selected from Mg, Ca, Sr, Ba, Ti, Zr, Nb, Mo, W, Zn, Al, Si, Ni, Mn, Cr, Fe, Mg, Sr, V, and a rare earth element; X is an element selected from O, F, S, and P; 0<p<1; M′ is at least one metal selected from Ru, Rh, Pd, Os, Ir, Pt, Mg, Ca, Sr, Ba, Ti, Zr, Nb, Mo, W, Zn, Al, Si, Ni, Mn, Cr, Fe, Mg, Sr, V, and a rare earth element; and M″ is at least one metal selected from Ti, V, Cr, Mn, Fe, Co, Ni, Cu, Al, Mg, Zr, and B.

The lithium ion battery may be prepared in the following manner.

First an anode is prepared.

As the anode, a lithium metal thin film may be used. Alternatively, the anode may include a current collector and an anode active material layer disposed on the current collector. For example, the anode may be used as the lithium metal thin film is disposed on a conductive substrate, which is the current collector. The lithium metal thin film may be integrated with the current collector.

In the anode, the current collector may comprise a metal selected from a stainless steel, copper, nickel, iron, and cobalt, but an embodiment is not limited thereto, and any suitable metal that has sufficient conductivity and is available in the art may be used. Other examples of the current collector may include a conductive oxide substrate and a conductive polymer substrate. Also, the current collector may have various structures, for example, a type having one surface of an insulating substrate coated with a conductive material, a conductive metal oxide or a conductive polymer, in addition to a structure in which the entire substrate formed of a conductive material. The current collector may be a flexible substrate. Thus, the current collector may be one which is easily bent. Also, after bending, restoration to its original shape of the current collector may be easy.

Also, the anode may further include an anode active material other than a lithium metal. The anode may be an alloy of a lithium metal and other anode active material, a complex of a lithium metal and other anode active material, or a combination of a lithium metal and other anode active material.

The other anode active material that may be included in the anode may be, for example, at least one selected from a lithium alloyable metal, a transition metal oxide, a non-transition metal oxide, and a carbonaceous material.

Examples of the lithium alloyable metal may include at least one selected from Si, Sn, Al, Ge, Pb, Bi, Sb, a Si—Y′ alloy (where, Y′ is at least one selected from an alkaline metal, an alkaline earth metal, a Group 13 element, a Group 14 element, a transition metal, and a rare earth element, and is not Si), or a Sn—Y′ alloy (where, Y′ is at least one selected from an alkaline metal, an alkaline earth metal, a Group 13 element, a Group 14 element, a transition metal, and a rare earth element, and is not Sn). Examples of the element Y′ may include at least one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, and Po.

Examples of the transition metal oxide may include a lithium titanium oxide, a vanadium oxide, or a lithium vanadium oxide.

Examples of the non-transition metal oxide may include SnO₂ or SiOₓ (where, 0<x<2).

The carbonaceous material may comprise at least one selected from a crystalline carbon and an amorphous carbon. The crystalline carbon may be graphite, such as shapeless, plate, flake, spherical, or fibrous natural graphite or artificial graphite, and the amorphous carbon may be soft carbon (low-temperature fired carbon) or hard carbon, mesophase pitch carbide, or fired cokes.

The anode may be prepared using an anode active material composition including an anode active material, a conducting material, a binder, and a solvent, the details of which can be determined by one of skill in the art without undue experimentation, instead of the lithium metal.

For example, after preparing the anode active material composition, a current collector is directly coated with the anode active material composition to form an anode plate, or the anode active material composition may be cast on a separate support to form an anode active material film, which is then separated from the support and laminated on a current collector to prepare an anode plate. The anode is not limited to a type described above, and any suitable type of anode available in the art may be used. For example, the anode may be prepared by printing anode active material ink including an anode active material or an electrolyte on a current collector using an additional inkjet method.

The anode active material may be in the form of a powder. The powder form of the anode active material may be used in an anode active material composition or an anode active material ink.

Examples of the conducting material may include carbon black or graphite particulates, but an embodiment is not limited thereto, and any suitable conducting material available in the art may be used.

Examples of the binder may include a vinylidene fluoride/hexafluoropropylene copolymer, polyvinylidene fluoride (PVDF), polyacrylonitrile, polymethylmethacrylate, polytetrafluoroethylene, mixtures thereof, or a styrene butadiene rubber polymer, but an embodiment is not limited thereto, and any suitable binder available in the art may be used.

Examples of the solvent may include N-methyl-pyrrolidone (NMP), acetone, and water, but an embodiment is not limited thereto, and any suitable solvent available in the art may be used.

The amounts of the anode active material, the conducting material, the binder, and the solvent are those levels that are generally used in the manufacture of a lithium battery. Depending on the use or structure of the lithium battery, one or more of the conducting material, the binder, and the solvent may be omitted.

Next, a composite cathode may be prepared as follows.

The composite cathode may be prepared in the same manner as in preparation of the anode active material composition, except that a cathode active material is used instead of the anode active material, and the gel electrolyte included in the composite electrode described above is used, i.e., a gel electrolyte comprising a solvent, a lithium salt, and an inorganic particle. In the cathode active material composition, the conducting material, the binder, and, optionally the solvent, are the same as those defined in connection with the anode active material composition.

The cathode active material composition may be prepared by mixing the cathode active material, the gel electrolyte, the conducting material, the binder, and optionally the solvent. In other words, the solvent may be omitted if desired. Alternatively, the cathode active material composition may be prepared by mixing the cathode active material, the conducting material, and the gel electrolyte. An aluminum current collector may be directly coated with the cathode active material composition and dried to prepare a cathode plate on which a cathode active material layer is formed. Alternatively, the cathode active material composition may be cast on a separate support, and then a film separated from the support may be laminated on the aluminum current collector to prepare a cathode plate on which a cathode active material layer is formed.

The cathode active material may be a lithium-containing metal oxide which may be any suitable material available in the art. For example, at least one type of a composite oxide of lithium and a metal selected from cobalt, manganese, nickel, and a combination thereof may be used as the cathode active material, and examples of the composite oxide may include a compound represented by one of the following chemical formulae: LiₐA_{1-b}B′_{b}D′₂ (where, 0.90≦a≦1.8, and 0≦b≦0.5); LiₐE_{1-b}B′_{b}O_{2-c}D′_{c} (where, 0.90≦a≦1.8, 0≦b≦0.5, and 0≦c≦0.05); LiE_{2-b}B′_{b}O_{4-c}D′_{c} (where, 0≦b≦0.5, and 0≦c≦0.05); LiₐNi_{1-b-c}Co_{b}B′_{c}D′_{α} (where, 0.90≦a≦1.8, 0≦b≦0.5, 0≦c 0.05, and 0<α<2); LiₐNi_{1-b-c}Co_{b}B′_{c}O_{2-α}F′_{α} (where, 0.90≦a≦1.8, 0≦b≦0.5, 0≦c≦0.05, and 0<α<2); LiₐNi_{1-b-c}Co_{b}B′_{c}O_{2-α}F′₂ (where, 0.90≦a≦1.8, 0≦b≦0.5, 0≦c≦0.05, and 0<α<2); LiₐNi_{1-b-c}Mn_{b}B′_{c}D′_{α} (where, 0.90≦a≦1.8, 0≦b≦0.5, 0≦c≦0.05, and 0<α≦2); LiₐNi_{1-b-c}Mn_{b}B′_{c}O_{2-α}F′_{α} (where, 0.90≦a≦1.8, 0≦b≦0.5, 0≦c≦0.05, and 0<α<2); LiₐNi_{1-b-c}Mn_{b}B′_{c}O_{2-α}F′₂ (where, 0.90≦a≦1.8, 0≦b≦0.5, 0≦c≦0.05, and 0<α<2); LiₐNi_{b}E_{c}G_{d}O₂ (where, 0.90≦a≦1.8, 0≦b≦0.9, 0≦c≦0.5, and 0.001≦d≦0.1); LiₐNi_{b}Co_{c}Mn_{d}GeO₂ (where, 0.90≦a≦1.8, 0≦b≦0.9, 0≦c≦0.5, 0≦d≦0.5, and 0.001≦e≦0.1); LiₐNiG_{b}O₂ (where, 0.90≦a≦1.8, and 0.001≦b≦0.1); LiₐCoG_{b}O₂ (where, 0.90≦a≦1.8, and 0.001≦b≦0.1); LiₐMnG_{b}O₂ (where 0.90≦a≦1.8, and 0.001≦b≦0.1); LiₐMn₂GbO₄ (where, 0.90≦a≦1.8, and 0.001 b≦0.1); QO₂; QS₂; LiQS₂; V₂O₅; LiV₂O₅; LiI′O₂; LiNiVO₄; Li_{(3-f)}J₂(PO₄)₃ (where, 0≦f≦2); Li_{(3-f)}Fe₂(PO₄)₃ (where, 0≦f≦2); and LiFePO₄.

In the formulas above, A is nickel (Ni), cobalt (Co), manganese (Mn), or a combinations thereof; B′ is aluminum (Al), nickel (Ni), cobalt (Co), manganese (Mn), chromium (Cr), iron (Fe), magnesium (Mg), strontium (Sr), vanadium (V), a rare earth element, or a combination thereof; D′ is oxygen (O), fluorine (F), sulfur (S), phosphorus (P), or a combination thereof; E is cobalt (Co), manganese (Mn), or a combination thereof; F′ is fluorine (F), sulfur (S), phosphorus (P), or a combination thereof; G is aluminum (Al), chromium (Cr), manganese (Mn), iron (Fe), magnesium (Mg), lanthanum (La), cerium (Ce), strontium (Sr), vanadium (V), or a combination thereof; Q is titanium (Ti), molybdenum (Mo), manganese (Mn), or a combination thereof; I′ is chromium (Cr), vanadium (V), iron (Fe), scandium (Sc), yttrium (Y), or a combination thereof; and J is vanadium (V), chromium (Cr), manganese (Mn), cobalt (Co), nickel (Ni), copper (Cu), or a combinations thereof.

Examples of the cathode active material may include LiCoO₂, LiMnₓO₂ₓ (where, x is 1 or 2), LiNi₁₋ₓMnₓO₂ₓ (where, 0<x<1), Ni_{1-x-y}CoₓMn_{y}O₂ (where, 0≦x≦0.5, and 0≦y≦0.5), and LiFePO₄.

A surface of the compound may have a coating layer, or the compound and a compound having a coating layer may be used as a mixture. The coating layer may include a compound of a coating element such as an oxide of a coating element, a hydroxide of a coating element, an oxyhydroxide of a coating element, an oxycarbonate of a coating element, or a hydroxyl carbonate of a coating element. The compound forming the coating layer may be amorphous or crystalline. The coating element included in the coating layer may be Mg, Al, Co, K, Na, Ca, Si, Ti, V, Sn, Ge, Ga, B, As, Zr, or a mixture thereof. A formation process of the coating layer may be any coating method (e.g., spray coating or immersion) that does not negatively affect physical properties of the cathode active material by using the elements above, and the coating method may be well understood by those of ordinary skill in the art, so the description of the coating method is omitted in the present specification.

Next, a separator to be disposed between the cathode and the anode is prepared. The separator for the lithium battery may be any suitable separator that is used in lithium batteries. The separator may have low resistance to migration of ions in an electrolyte and have an excellent electrolyte-retaining ability. For example, the separator may be selected from glass fiber, polyester, Teflon, polyethylene, polypropylene, polytetrafluoroethylene (PTFE), and a combination thereof, each of which may be a non-woven or woven fabric. For example, a rollable separator including polyethylene or polypropylene may be used for a lithium ion battery. A separator with a good organic electrolyte solution-retaining ability may be used for a lithium ion polymer battery. For example, the separator may be manufactured in the following manner.

A polymer resin, a filler, and a solvent may be mixed together to prepare a separator composition. Then, an electrode is directed coated with the separator composition, and then dried to form the separator. Alternatively, the separator composition may be cast on a support and then dried to form a separator film, which may then be separated from the support and laminated on an electrode to form the separator.

The polymer resin used to manufacture the separator may be any material that is commonly used as a binder for electrode plates. For example, the polymer resin may be a vinylidenefluoride/hexafluoropropylene copolymer, polyvinylidene fluoride (PVDF), polyacrylonitrile, polymethylmethacrylate, or a mixture thereof.

Next, an electrolyte is prepared.

The electrolyte may be a liquid electrolyte, a gel electrolyte, or a solid electrolyte. For example, the electrolyte may be an organic electrolyte solution. The organic electrolyte solution may be prepared by dissolving a lithium salt in an organic solvent.

The organic solvent may be any appropriate solvent available as an organic solvent in the art. For example, the organic solvent may be propylenecarbonate, ethylenecarbonate, fluoroethylenecarbonate, butylenecarbonate, dimethylcarbonate, diethylcarbonate, methylethylcarbonate, methylpropylcarbonate, ethylpropylcarbonate, methylisopropylcarbonate, dipropylcarbonate, dibutylcarbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethylsulfoxide, dioxane, 1,2-dimethoxyethane, sulfolane, dichloroethane, chlorobenzene, nitrobenzene, diethyleneglycol, dimethylether, or mixtures thereof.

The lithium salt may be any material available as a lithium salt in the art.

For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where, x and y are natural numbers), LiCl, LiI, or a mixture thereof.

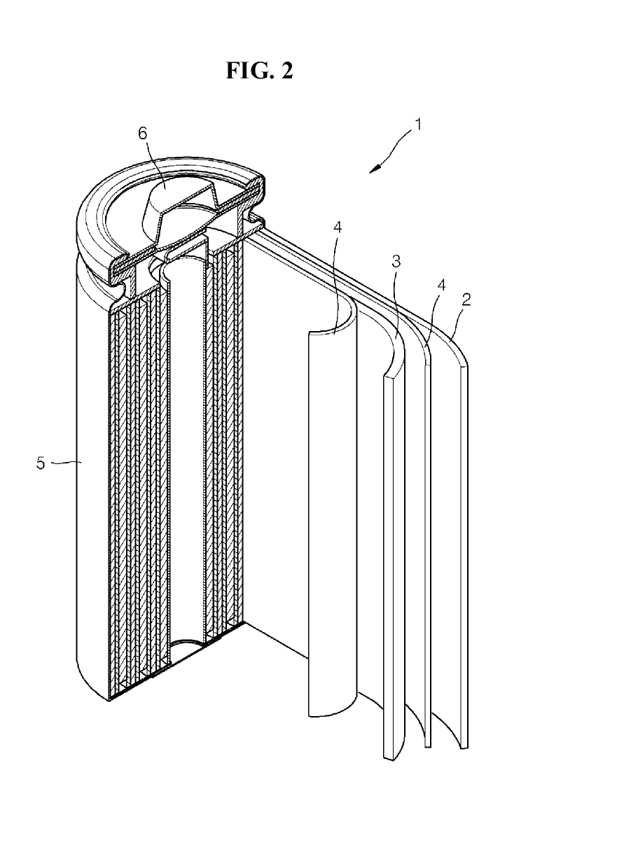

For example, as shown in FIG. 2, a lithium battery 1 includes a cathode 3, an anode 2, and a separator 4. The cathode 3, the anode 2 and the separator 4 are wound or folded, and then accommodated in a battery case 5. Then, the battery case 5 is filled with an organic electrolyte solution and sealed with a cap assembly 6, thereby completing manufacture of the lithium battery 1. The battery case 5 may be a cylindrical type, a rectangular type, or a thin-film type. For example, the lithium battery 1 may be a large-sized thin-film type battery. The lithium battery 1 may be a lithium ion battery.

The separator may be interposed between the cathode and the anode to form a battery assembly. Alternatively, the battery assembly may be stacked in a bi-cell structure and impregnated with the organic electrolyte solution. The resultant is put into a pouch and hermetically sealed, thereby completing manufacture of a lithium ion polymer battery.

Alternatively, a plurality of battery assemblies may be stacked to form a battery pack, which may be used in any device that requires high capacity and high output, for example, in a laptop computer, a smart phone, or an electric vehicle (EV).

The lithium battery has excellent lifespan characteristics and high rate characteristics and thus may be used in an electric vehicle (EV). For example the lithium battery may be used in a hybrid electric vehicle such as a plug-in hybrid electric vehicle (PHEV). Further, the lithium battery may be used in, for example, an electric bike or a power tool, which needs a large capacity of electrical power storage.

According to another embodiment, a method of preparing a composite electrode includes mixing starting materials including a solvent, a lithium salt, and an inorganic particle to prepare a gel electrolyte, wherein an electrode member is added to the starting material before, after, or during the mixing of the starting materials, and the electrode member includes at least one of an electrode active material and a conducting material. For example, the electrode member is porous carbon and/or Ag.

The solvent, lithium salt, and inorganic particle are the same as defined in connection with the description of the composite electrode.

The gel electrolyte including a gel phase is prepared by mixing the solvent, lithium salt, and inorganic particle, and the electrode member such as the electrode active material or the conducting material may be added in any step of the process for preparing the gel electrolyte to form a composite electrode.

An exemplary embodiment will be described in further detail with reference to the following examples. These examples are for illustrative purposes only and are not intended to limit the scope of an embodiment.

### EXAMPLES

### Preparation of Gel Electrolyte

### Example 1

### Preparation of Solvent+Lithium Salt+7 wt % SiO₂ Gel Electrolyte

Lithium bis(trifluoromethane)sulfonamide (LiTFSi) was added to 93 g of polyethyleneglycol dimethylether (PEGDME, Mw=500, Aldrich, 445886, liquid state) in a molar ratio of PEGDME:Li of 10:1, and 7 g of SiO₂ having a particle diameter of about 7 nm to about 20 nm was added thereto, then stirred for about 20 minutes to form a mixture. Then, the mixture was poured into a Teflon dish, dried in a drying chamber at room temperature for 2 days, and vacuum-dried at 60° C. overnight to prepare a gel electrolyte in the form of a transparent film. An amount of SiO₂ was 7 weight %, based on the total weight of polyethyleneglycol dimethylether and SiO₂.

### Example 2

### Preparation of Solvent+Lithium Salt+5 wt % SiO₂ Gel Electrolyte

A gel electrolyte was prepared in the same manner as in Example 1, except that an amount of SiO₂ was included in an amount of 5 weight %, based on the total weight of polyethyleneglycol dimethylether and SiO₂.

### Example 3

### Preparation of Composite Cathode Including Solvent+Lithium Salt+12 wt % SiO₂ Gel Electrolyte

A gel electrolyte was prepared in the same manner as in Example 1, except that an amount of SiO₂ was changed to 12 weight %, based on the total weight of polyethyleneglycol dimethylether and SiO₂.

### Example 4

### Using TiO₂ Instead of SiO₂

A gel electrolyte was prepared in the same manner as in Example 1, except that TiO₂ was used as an inorganic particle instead of SiO₂.

### Example 5

### Using N,N-Diethylmethylamine (DEMA) Solvent Instead of PEGDME

A gel electrolyte was prepared in the same manner as in Example 1, except that N,N-diethylmethylamine (DEMA) was used as a solvent instead of PEGMDME in a liquid state.

### Comparative Example 1

### Not Adding SiO₂

An electrolyte was prepared in the same manner as in Example 1, except that SiO₂ was not added. The resulting electrolyte was a liquid.

### Comparative Example 2

### Using Mw=1000 PEGDME

93 g of polyethyleneglycol dimethylether (PEGDME, Mw=1000, Aldrich, 445894, solid state) was dissolved in 100 milliliters (mL) of acetonitrile to prepare a PEO solution, and LiTFSi was added thereto so that a molar ratio of PEGDME:Li was 10:1 and dissolved while stirring. Then, the solution was poured into a Teflon dish, dried in a drying chamber at room temperature for 2 days, and vacuum-dried at 60° C. overnight to prepare a solid electrolyte in the form of a film from which a solvent had been removed.

### Comparative Example 3

### Using Mw=2000 PEGDME

93 g of polyethyleneglycol dimethylether (PEGDME, Mw=2000, Aldrich, solid state) was dissolved in 100 mL of acetonitrile to prepare a PEO solution, and LiTFSi was added thereto in molar ratio of PEGDME:Li of 10:1 and then dissolved while stirring. Then, the solution was poured into a Teflon dish, dried in a dry chamber at room temperature for 2 days, and vacuum-dried at 60° C. overnight to prepare a solid electrolyte in the form of a film from which a solvent had been removed.

### Comparative Example 4

### 20 wt % SiO₂

A sample was prepared in the same manner as in Example 1, except that an amount of SiO₂ was changed to 20 weight %, based on the total weight of polyethyleneglycol dimethylether and SiO₂. A white liquid was obtained, not a gel electrolyte.

### Comparative Example 5

### 100 nm SiO₂

A sample was prepared in the same manner as in Example 1, except that SiO₂ having a particle diameter of 100 nm was used. A white liquid was obtained, not a gel electrolyte.

### Preparation of Lithium Air Battery

### Example 6

### Preparation of Composite Cathode/Solid Electrolyte Layer Structure

Carbon black (Printex®, Orion Engineered Chemicals, USA) was vacuum-dried at 120° C. for 24 hours. The dried carbon black and the gel electrolyte prepared in Example 1 were weighed at a predetermined weight ratio and mechanically kneaded while heating to maintain a temperature in a range of about 40° C. to about 60° C. to prepare a composite cathode paste. The weight ratio of the carbon black and the gel electrolyte was 1:5.

The composite cathode paste was spread on a solid electrolyte layer, LICGC™ (LATP, available from Ohara) having a thickness of 250 μm and coated thereon by using a roller to prepare a composite cathode/solid electrolyte layer structure.

### Examples 7 to 10

Composite cathode/solid electrolyte layer structures were prepared in the same manner as in Example 1, except that the gel electrolytes prepared in Examples 2 to 5 were respectively used instead of the gel electrolyte prepared in Example 1.

### Comparative Example 6

A composite cathode/solid electrolyte layer structure was prepared in the same manner as in Example 1, except that the liquid electrolyte prepared in Comparative Example 1 was used instead of the gel electrolyte prepared in Example 1.

### Comparative Examples 7 and 8

Composite cathode/solid electrolyte layer structures were prepared in the same manner as in Example 1, except that the gel electrolytes prepared in Comparative Examples 2 and 3 were respectively used instead of the gel electrolyte prepared in Example 1.

### Comparative Examples 9 and 10

### Unable to Form Electrolyte

Since an electrolyte was not formed in Comparative Examples 4 and 5, composite cathode/solid electrolyte layer structures including an electrolyte were not able to be prepared.

### Comparative Example 11

### Using 100 k PEO

1.15 g of polyethylene oxide (PEO, Mw=100,000 Da, Aldrich, 181986) was dissolved in 50 mL of acetonitrile to prepare a PEO solution, and LiTFSi was added thereto in molar ratio of PEGDME:Li of 10:1 and dissolved while stirring. Then, the solution was poured into a Teflon dish, dried in a drying chamber at room temperature for 2 days, and vacuum-dried at 60° C. overnight to prepare an electrolyte film from which a solvent had been removed.

Carbon black (Printex®, Orion Engineered Chemicals, USA) was vacuum-dried at 120° C. for 24 hours. The dried carbon black and the prepared electrolyte were weighed at a predetermined weight ratio and mechanically kneaded while heating to maintain a temperature in a range of about 40° C. to about 60° C. to prepare a composite cathode paste. The weight ratio of the carbon black and the solid electrolyte was 1:5.

The composite cathode paste was spread on a solid electrolyte layer, LICGC™, (LATP, available from Ohara) having a thickness of 250 μm and coated thereon using a roller to prepare a composite cathode/solid electrolyte layer structure.

### Comparative Example 12

### Formation of Gel Electrolyte Layer/Carbon Cathode as Separate Layer

Carbon black (Printex®, Orion Engineered Chemicals, USA) was vacuum-dried at 120° C. for 24 hours. The dried carbon black and a binder (PTFE, DuPont™ Teflon® PTFE DISP 30) were mechanically kneaded to prepare a cathode paste. A weight ratio of the carbon black and the binder was 1:5.

The gel electrolyte prepared in Example 1 was stacked on a solid electrolyte layer, LICGC™, (LATP, available from Ohara) having a thickness of 250 μm to form a gel electrolyte layer, and then the cathode paste was spread and coated on the gel electrolyte layer using a roller to prepare a cathode/gel electrolyte layer/solid electrolyte layer structure.

### Example 11

### Preparation of Lithium Air Battery

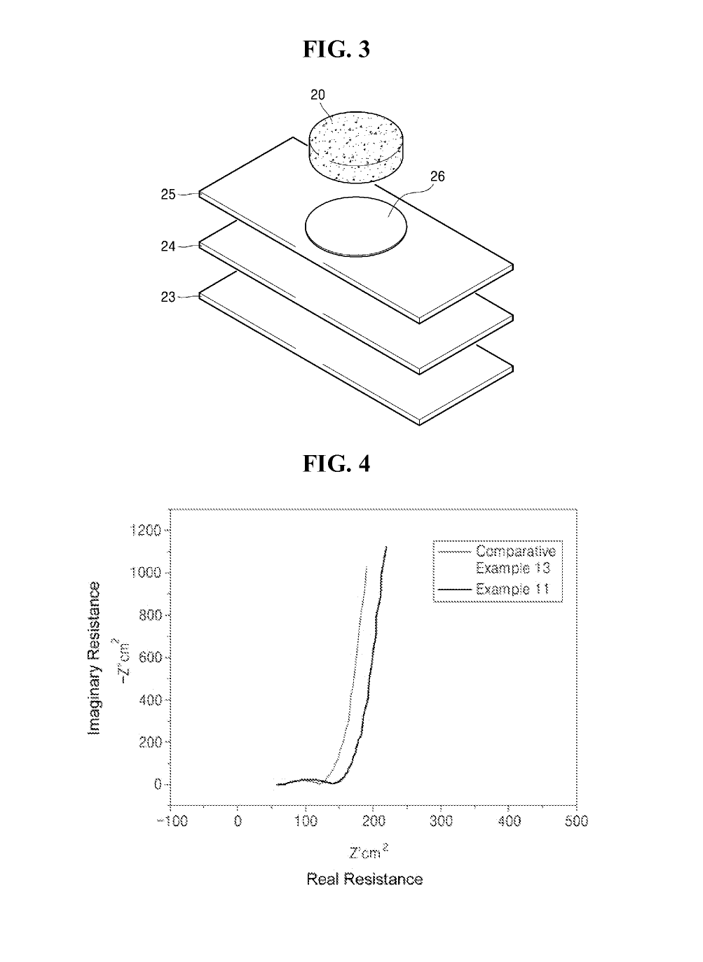

As shown in FIG. 3, an anode 23 was prepared by attaching Li metal, on which brushing had been performed, on a Cu foil, and a PEO layer was used as an anode interlayer 24 for preventing direct contact between LATP and Li. Here, the PEO layer was prepared as follows.

Polyethyleneoxide (MW 600,000 Da) and LiTFSi were added to 100 mL of acetonitrile and mixed for about 12 hours or more. A ratio of LiTFSi and polyethyleneoxide was a molar ratio of 1:18.

The anode interlayer 24 was stacked on the lithium metal 23, and the composite cathode 26/solid electrolyte layer 25 structure prepared in Example 6 was disposed thereon to prepare a cell having a structure shown in FIG. 3. As shown in FIG. 3, the LATP solid electrolyte layer 25, i.e., an oxygen blocking layer, was positioned to contact the anode interlayer 24.

A carbon paper (35-DA, available from SGL) 20 was placed on the other surface of the composite cathode 26, and a Ni mesh, as a current collector, was placed thereon, thereby completing manufacture of a lithium air battery.

### Examples 12 to 15

### Manufacture of Lithium Air Batteries

Lithium air batteries were manufactured in the same manner as in Example 11, except that the structures prepared in Examples 7 to 10 were respectively used instead of the structure prepared in Example 6.

### Comparative Examples 13 to 17

### Manufacture of Lithium Air Batteries

Lithium air batteries were manufactured in the same manner as in Example 11, except that the structures prepared in Comparative Examples 6 to 8, 11, and 12 were respectively used instead of the structure prepared in Example 6.

### Evaluation Example 1

### Evaluation of Phase Stability of Gel

The mixture prepared in Example 1, including the polyethyleneglycol dimethylether, LiTFSi, and the SiO₂, was poured into a vial to occupy about ⅕ of the total volume from the bottom of the vial, dried in a drying chamber at room temperature for 2 days, and vacuum-dried at 60° C. overnight to prepare a gel electrolyte in the form of a transparent gel, which formed on the bottom of the vial.

The vial was held upside down at 60° C. for 24 hours. The gel electrolyte at the bottom of the vial did not flow down along an inner wall of the vial. Therefore, it was confirmed that a strong gel was formed.

### Evaluation Example 2

### Impedance Measurement

Resistances of membrane electrode assemblies of the lithium air batteries prepared in Example 11 and Comparative Example 11 were measured using an impedance analyzer (Solartron 1260A Impedance/Gain-Phase Analyzer) with a 2-probe method at 25° C. A current density was 0.4 A/cm², an amplitude was ±10 mV, and a frequency range was from about 0.1 Hz to about 10 KHz. A Nyquist plot with respect to the impedance measurement results of the lithium air batteries of Example 11 and Comparative Example 11 is shown in FIG. 4. An interfacial resistance (R_{inf}) in FIG. 4 is determined by a location and a size of a semi-circle and an ionic resistance (Rᵢₒₙ) is determined by a slope of a line proceeding in an upper right direction. The analysis results of the graph shown in FIG. 4 are shown in Table 4.

TABLE 1

| | Interfacial | Ionic | Ion |
|---|---|---|---|
| | resistance (R_{inf}) | resistance (Rᵢₒₙ) | conductivity |
| | [ohm · cm²] | [ohm · cm²] | [s/cm] |
| Example 11 | 78.8401 | 70.1391 | 5 × 10⁻³ |
| Comparative | 62.7828 | 119.78 | 2 × 10⁻³ |
| Example 13 | | | |
| Comparative | 183.55 | 120.50 | <1 × 10⁻⁴ |
| Example 16 | | | |

As shown in Table 1, the lithium air battery prepared in Example 11 had a decreased ionic resistance compared to those of the membrane electrode assemblies prepared in Comparative Examples 13 and 16, and as a result, the ion conductivity of the lithium air battery prepared in Example 11 increased.

### Evaluation Example 3

### Evaluation of Charging/Discharging Characteristics

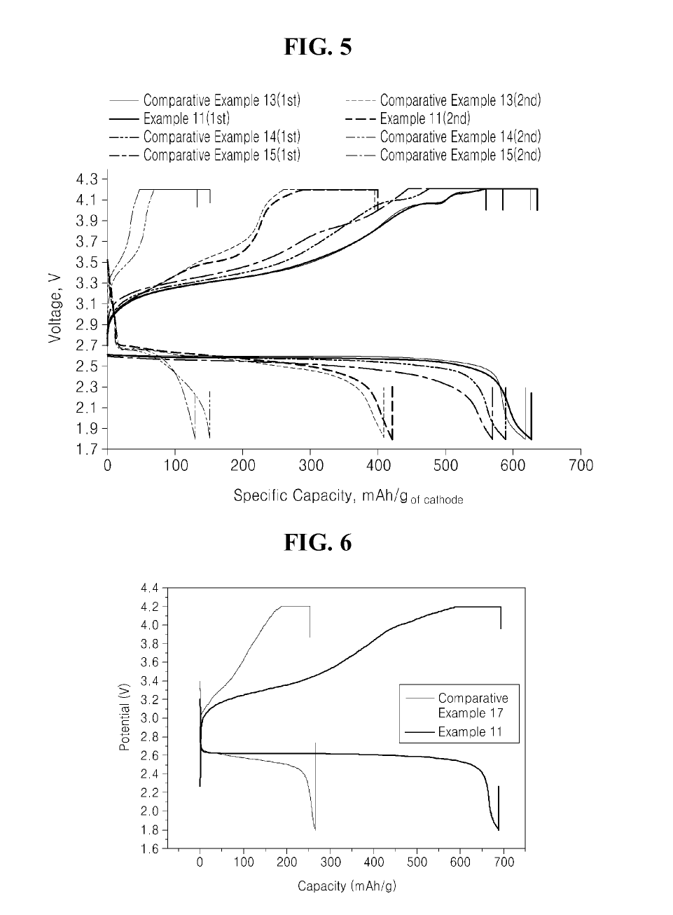

At a temperature of 60° C. in an 1 atm oxygen atmosphere, a charging/discharging cycle was performed on each of the lithium air batteries prepared in Examples 11 to 15 and Comparative Examples 13 to 16 by discharging the batteries with a constant current of 0.24 mA/cm² to 1.7 V (vs. Li), charging the batteries with the same constant current to 4.2 V, and then charging the batteries at a constant voltage to the cut-off current of 0.02 mA/cm². Some of the charging/discharging test results after the 1^{st} cycle and the 2^{nd} cycle are shown in Table 2 and FIG. 5.

In a discharge capacity (mAh/g), a unit weight (g) means a weight of a cathode including a carbon-based material, a lithium salt, and an electrolyte.

A capacity retention rate is calculated by Equation 1.

Capacity retention rate [%]=[Discharge capacity after the 2^{nd} cycle/Discharge capacity after the 1^{st} cycle]×100 Equation 1

TABLE 2

| | Discharge capacity | Discharge capacity | Capacity |
|---|---|---|---|
| | after the 1^{st} cycle | after the 2^{nd} cycle | retention |
| | [mAh/g] | [mAh/g] | rate [%] |
| Example 11 | 620 | 420 | 67.9 |
| Comparative | 615 | 410 | 66.3 |
| Example 13 | | | |
| Comparative | 590 | 150 | 25.8 |
| Example 14 | | | |
| Comparative | 580 | 120 | 23.1 |
| Example 15 | | | |
| Comparative | 590 | 93.5 | 16.8 |
| Example 16 | | | |

As shown in Table 2, the lithium air battery including the gel electrolyte of Example 11 had the similar discharge capacity with that of the lithium air battery including the liquid electrolyte prepared in Comparative Example 13 after the 1^{st} and 2^{nd} cycles. That is, the lithium air battery including the gel electrolyte prepared in Example 11 had the similar charging/discharging characteristics with those of an air battery including a liquid electrolyte.

Also, the lithium air batteries including the solid electrolyte prepared in Comparative Examples 14 and 15 had significantly reduced discharge capacities after 2^{nd} cycle, and thus lifespan characteristics of the lithium air batteries including the solid electrolyte prepared in Comparative Examples 14 and 15 were poor. While not wanting to be bound by theory, it is presumed that lifespan characteristics of the batteries become so poor since the polymer electrolyte, which has been pushed out of original site within the cathode during a discharging process, was not able to return into the same site during a charging process.

### Evaluation Example 4

### Charging/Discharging Characteristics Evaluation

At a temperature of 60° C. in an 1 atm oxygen atmosphere, a charging/discharging cycle was performed on each of the lithium air batteries prepared in Example 11 and Comparative Example 17 by discharging the batteries with a constant current of 0.24 mA/cm² to 1.7 V (vs. Li), charging the batteries with the same constant current to 4.2 V, and then charging the batteries at a constant voltage to the cut-off current of 0.02 mA/cm². Some of the charging/discharging test results after the 1^{st} cycle are shown in Table 3 and FIG. 6.

In a discharge capacity (mAh/g), a unit weight (g) means a weight of a cathode including a carbon-based material, a lithium salt, and an electrolyte.

TABLE 3

| | Discharge capacity |
|---|---|
| | after the 1^{st} cycle |
| | [mAh/g] |
| Example 11 | 700 |
| Comparative | 270 |
| Example 17 | |

As shown in Table 3, the lithium air battery including the composite cathode prepared in Example 11 had a significantly improved discharge capacity compared to that of the lithium air battery prepared in Comparative Example 17 having a two-layered structure including a gel electrolyte layer and a cathode layer as a separate layer.

It is presumed that an increased wettability between carbon and an electrolyte in the gel electrolyte causes increased contact area between oxygen and lithium thus results in an improved discharge capacity.

As described above, according to the one or more of the above exemplary embodiments, a lithium air battery may have improved charging/discharging characteristics by including a gel electrolyte and a composite electrode, wherein the gel electrolyte is obtained by mixing a solvent, a lithium salt, and an inorganic particle, and the composite electrode includes a conducting material.

It should be understood that the exemplary embodiments described therein should be considered in a descriptive sense only and not for purposes of limitation. Descriptions of features, advantages, or aspects within each embodiment should typically be considered as available for other similar features, advantages, or aspects in other embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A composite electrode comprising:
a gel electrolyte comprising a solvent, a lithium salt, and an inorganic particle; and
an electrode member comprising at least one of an electrode active material and a conducting material,
wherein the gel electrolyte is in a form of a gel.

2. The composite electrode of claim 1, wherein the inorganic particle is electrochemically inert.

3. The composite electrode of claim 1, wherein the inorganic particle comprises at least one selected from a metal oxide, a metal nitride, a metal nitrate, a metal carbide, and a noble metal.

4. The composite electrode of claim 1, wherein the inorganic particle comprises at least one selected from SiO₂, TiO₂, Al₂O₃, and AlN.

5. The composite electrode of claim 1, wherein a particle diameter of the inorganic particle is less than 100 nanometers.

6. The composite electrode of claim 1, wherein the inorganic particle is contained in the gel electrolyte in an amount of about 20 weight percent or less, based on the total weight of the gel electrolyte.

7. The composite electrode of claim 1, wherein a molecular weight of the solvent is less than about 1000 Daltons.

8. The composite electrode of claim 1, wherein the solvent comprises at least one selected from an organic solvent, an ionic liquid, and an oligomer.

9. The composite electrode of claim 8, wherein the organic solvent comprises at least one selected from propylenecarbonate, ethylenecarbonate, fluoroethylenecarbonate, vinylethylenecarbonate butylenecarbonate, dimethylcarbonate, diethylcarbonate, methylethylcarbonate, methylpropylcarbonate, ethylpropylcarbonate, methylisopropylcarbonate, dipropylcarbonate, dibutylcarbonate, benzonitrile, acetonitrile, tetrahydrofuran, 2-methyltetrahydrofuran, γ-butyrolactone, dioxolane, 4-methyldioxolane, dimethylacetamide, dimethylsulfoxide, dioxane, 1,2-dimethoxyethane, sulfolane, dichloroethane, chlorobenzene, nitrobenzene, succinonitrile, diethyleneglycol dimethylether, tetraethyleneglycol dimethylether, polyethyleneglycol dimethylether, dimethylether, diethylether, dibutylether, dimethoxyethane, 2-methyltetrahydrofuran, and tetrahydrofuran.

10. The composite electrode of claim 1, wherein the lithium salt comprises at least one selected from lithium bis(trifluoromethane)sulfonimide, LiPF₆, LiBF₄, LiAsF₆, LiClO₄, LiNO₃, lithium bis(oxalato) borate, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and lithium trifluoromethanesulfonate.

11. The composite electrode of claim 1, wherein an ion conductivity of the gel electrolyte is about 1×10⁻⁴ Siemens per centimeter or greater at a temperature of 25° C.

12. The composite electrode of claim 1, wherein the gel electrolyte does not flow down from a bottom of a vial, when the vial is flipped upside down at 60° C. for 24 hours.

13. The composite electrode of claim 1, wherein a composition ratio of the electrode member and the gel electrolyte is about 200 parts to about 800 parts of the gel electrolyte with respect to 100 parts by weight of the electrode member.

14. The composite electrode of claim 1, wherein the conducting material comprises at least one of a porous carbon material and a porous metal material.

15. An electrochemical cell comprising:
the composite electrode of claim 1; and
a counter electrode.

16. The electrochemical cell of claim 15, further comprising at least one electrolyte selected from a liquid electrolyte, a gel electrolyte, and a solid electrolyte, wherein the electrolyte is disposed between the composite electrode and the counter electrode.

17. A lithium air battery comprising the electrochemical cell of claim 15, wherein the conducting material of the composite electrode, which is disposed in the lithium air battery, comprises at least one of a porous carbon and a metal.

18. A lithium-ion battery comprising the electrochemical cell of claim 15 disposed in a case.

19. The lithium air battery of claim 18, wherein the electrode active material of the composite electrode disposed in the lithium ion battery comprises a lithium transition metal oxide represented by one of Formulas 1 to 6,
LiₓCo_{1-y}M_{y}O_{2-α}X_{α}, Formula 1
LiₓCo_{1-y-z}Ni_{y}M_{z}O_{2-α}X_{α}, Formula 2
LiₓMn_{2-y}M_{y}O_{4-α}X_{α}, Formula 3
LiₓCo_{2-y}M_{y}O_{4-α}X_{α}, Formula 4
LiₓMe_{y}M_{z}PO_{4-α}X_{α}, Formula 5
pLi₂M′O₃-(1−p)LiM″O₂, Formula 6
wherein, in Formulas 1 to 6,
0.90≦x≦1.1, 0≦y≦0.9, 0≦z≦0.5, 1−y−z>0, and 0≦α≦2;
Me is a metal selected from the group Ti, V, Cr, Mn, Fe, Co, Ni, Cu, Al, Mg, Zr, and B;
M is at least one element selected from the group Mg, Ca, Sr, Ba, Ti, Zr, Nb, Mo, W, Zn, Al, Si, Ni, Mn, Cr, Fe, Mg, Sr, V, and a rare earth element;
X is an element selected from the group O, F, S, and P;
0<p<1;
M′ is at least one metal selected from the group Ru, Rh, Pd, Os, Ir, Pt, Mg, Ca, Sr, Ba, Ti, Zr, Nb, Mo, W, Zn, Al, Si, Ni, Mn, Cr, Fe, Mg, Sr, V, and a rare earth element; and
M″ is at least one metal selected from the group Ti, V, Cr, Mn, Fe, Co, Ni, Cu, Al, Mg, Zr, and B.

20. A method of preparing a composite electrode, the method comprising:
combining a solvent, a lithium salt, an inorganic particle and an electrode member to prepare the composite electrode,
wherein the electrode member comprises at least one of an electrode active material and a conducting material.

21. The method of claim 20, wherein the solvent, lithium salt, and the inorganic particle are first combined to prepare a gel electrolyte, and then
combining the electrode member with the gel electrolyte to prepare the composite electrode.
